(19) United States
(12) Patent Application Publication
(10) Pub. No.: US 2024/0354979 A1
(43) Pub. Date: Oct. 24, 2024

(54) MULTI-SOURCE POSE MERGING FOR DEPTH ESTIMATION

(71) Applicant: QUALCOMM Incorporated, San Diego, CA (US)

(72) Inventors: Sai Madhuraj Jadhav, Foster City, CA (US); Amin Ansari, Kirkland, WA (US); Yunxiao Shi, San Diego, CA (US)

(21) Appl. No.: 18/435,458

(22) Filed: Feb. 7, 2024

Related U.S. Application Data
(60) Provisional application No. 63/497,884, filed on Apr. 24, 2023.

(51) Int. Cl. G06T 7/55; G06T 7/70; G06T 11/00

(52) U.S. Cl. CPC G06T 7/55; G06T 7/70; G06T 11/00; G06T 2207/20081; G06T 2207/20212; G06T 2207/30244

(57) ABSTRACT

This disclosure provides systems, methods, and devices for image signal processing that support multi-source pose merging for depth estimation. In a first aspect, a method of image processing includes generating, in accordance with first image data of a first image frame and second image data of a second image frame, a first mask indicating one or more pixels determined not to change position between the first image frame and the second image frame, generating, in accordance with the first image data and the second image data, a second mask indicating one or more pixels determined not to change position between the first image frame and the second image frame, and combining the first mask with the second mask to generate a third mask. Other aspects and features are also claimed and described.

### CROSS-REFERENCE TO RELATED APPLICATIONS

This application claims the benefit of U.S. Provisional Patent Application No. 63/497,884, entitled, “MULTI-SOURCE POSE MERGING FOR DEPTH ESTIMATION,” filed on Apr. 24, 2023, which is expressly incorporated by reference herein in its entirety.

### TECHNICAL FIELD

Aspects of the present disclosure relate generally to image processing, and more particularly, to depth estimation. Some features may enable and provide improved image processing, including improved pose determination for depth estimation.

### INTRODUCTION

Image capture devices are devices that can capture one or more digital images, whether still images for photos or sequences of images for videos. Capture devices can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

One particular application of image processing is depth estimation. Depth estimation may be particularly useful in autonomous driving, assistive robotics, augmented or virtual scene composition, and image editing applications. As one particular example, depth estimation using multiple images may be used to estimate a distance between an autonomous vehicle and one or more external objects, such as one or more other vehicles, trees, or other objects.

Multiple methods for depth estimation exist. Some methods, such as calibrated stereo and multi-view stereo applications, may use images captured by multiple cameras for depth estimation. Some methods, such as monocular video learning methods or structure from motion methods, may use video captures using a single camera to for depth estimation. Some methods, such as monocular depth estimation methods, may use multiple images captured by a single camera at multiple positions for depth estimation. Monocular depth estimation may, however, include determination of a change in position of a camera when the camera captures a first image and the camera captures a second image. Methods for such determination may be prone to error.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In some aspects, first and second masks may be generated using image data of first and second image frames, the first and second masks indicating one or more pixels corresponding to one or more objects determined to be moving between the first image frame and the second image frame. The first and second explainability masks may be combined to generate a third explainability mask for use in depth estimation. Use of multiple masks to generate a combined mask may allow for generation of masks using different information sources and combination of those masks in a final mask. Thus, strengths of different information sources may be obtained through use of a combined mask, as discussed herein.

The use of a combined mask, such as a combined explainability mask, for depth estimation may include generation of first and second explainability masks using first and second sets of pose information generated by first and second sources. For example, the first explainability mask may be generated using pose information from a positioning engine, such as internal positioning engine of the device including a camera that captured the first and second images. The second explainability mask may be generated using pose information from a pose estimation network, such as an external pose estimation network. Use of explainability masks generated using different pose estimation sources may allow for more accurate pose estimation in generating the combined third explainability mask, which may, in turn, allow for more accurate depth estimation, as discussed herein. Depth estimation using a combined mask may further include determination of a photometric loss using the combined mask.

In one aspect of the disclosure, a method for image processing includes receiving first image data comprising first image data comprising one or more image frames; generating, in accordance with first image data of a first image frame and second image data of a second image frame, a first mask indicating one or more pixels determined not to change position between the first image frame and the second image frame, generating, in accordance with the first image data and the second image data, a second mask indicating one or more pixels determined not to change position between the first image frame and the second image frame, and combining the first mask with the second mask to generate a third mask.

In an additional aspect of the disclosure, an apparatus includes at least one processor and a memory coupled to the at least one processor. The at least one processor is configured to perform operations including generating, in accordance with first image data of a first image frame and second image data of a second image frame, a first mask indicating one or more pixels determined not to change position between the first image frame and the second image frame, generating, in accordance with the first image data and the second image data, a second mask indicating one or more pixels determined not to change position between the first image frame and the second image frame, and combining the first mask with the second mask to generate a third mask.

In an additional aspect of the disclosure, an apparatus includes means for generating, in accordance with first image data of a first image frame and second image data of a second image frame, a first mask indicating one or more pixels determined not to change position between the first image frame and the second image frame, means for generating, in accordance with the first image data and the second image data, a second mask indicating one or more pixels determined not to change position between the first image frame and the second image frame, and means for combining the first mask with the second mask to generate a third mask.

In an additional aspect of the disclosure, a non-transitory computer-readable medium stores instructions that, when executed by a processor, cause the processor to perform operations. The operations include generating, in accordance with first image data of a first image frame and second image data of a second image frame, a first mask indicating one or more pixels determined not to change position between the first image frame and the second image frame, generating, in accordance with the first image data and the second image data, a second mask indicating one or more pixels determined not to change position between the first image frame and the second image frame, and combining the first mask with the second mask to generate a third mask.

Methods of image processing described herein may be performed by an image capture device and/or performed on image data captured by one or more image capture devices. Image capture devices, devices that can capture one or more digital images, whether still image photos or sequences of images for videos, can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computing devices such as webcams, video surveillance cameras, or other devices with digital imaging or video capabilities.

The image processing techniques described herein may involve digital cameras having image sensors and processing circuitry (e.g., application specific integrated circuits (ASICs), digital signal processors (DSP), graphics processing unit (GPU), or central processing units (CPU)). An image signal processor (ISP) may include one or more of these processing circuits and configured to perform operations to obtain the image data for processing according to the image processing techniques described herein and/or involved in the image processing techniques described herein. The ISP may be configured to control the capture of image frames from one or more image sensors and determine one or more image frames from the one or more image sensors to generate a view of a scene in an output image frame. The output image frame may be part of a sequence of image frames forming a video sequence. The video sequence may include other image frames received from the image sensor or other images sensors.

In an example application, the image signal processor (ISP) may receive an instruction to capture a sequence of image frames in response to the loading of software, such as a camera application, to produce a preview display from the image capture device. The image signal processor may be configured to produce a single flow of output image frames, based on images frames received from one or more image sensors. The single flow of output image frames may include raw image data from an image sensor, binned image data from an image sensor, or corrected image data processed by one or more algorithms within the image signal processor. For example, an image frame obtained from an image sensor, which may have performed some processing on the data before output to the image signal processor, may be processed in the image signal processor by processing the image frame through an image post-processing engine (IPE) and/or other image processing circuitry for performing one or more of tone mapping, portrait lighting, contrast enhancement, gamma correction, etc. The output image frame from the ISP may be stored in memory and retrieved by an application processor executing the camera application, which may perform further processing on the output image frame to adjust an appearance of the output image frame and reproduce the output image frame on a display for view by the user.

After an output image frame representing the scene is determined by the image signal processor and/or determined by the application processor, such as through image processing techniques described in various embodiments herein, the output image frame may be displayed on a device display as a single still image and/or as part of a video sequence, saved to a storage device as a picture or a video sequence, transmitted over a network, and/or printed to an output medium. For example, the image signal processor (ISP) may be configured to obtain input frames of image data (e.g., pixel values) from the one or more image sensors, and in turn, produce corresponding output image frames (e.g., preview display frames, still-image captures, frames for video, frames for object tracking, etc.). In other examples, the image signal processor may output image frames to various output devices and/or camera modules for further processing, such as for 3A parameter synchronization (e.g., automatic focus (AF), automatic white balance (AWB), and automatic exposure control (AEC)), producing a video file via the output frames, configuring frames for display, configuring frames for storage, transmitting the frames through a network connection, etc. Generally, the image signal processor (ISP) may obtain incoming frames from one or more image sensors and produce and output a flow of output frames to various output destinations.

In some aspects, the output image frame may be produced by combining aspects of the image correction of this disclosure with other computational photography techniques such as high dynamic range (HDR) photography or multi-frame noise reduction (MFNR). With HDR photography, a first image frame and a second image frame are captured using different exposure times, different apertures, different lenses, and/or other characteristics that may result in improved dynamic range of a fused image when the two image frames are combined. In some aspects, the method may be performed for MFNR photography in which the first image frame and a second image frame are captured using the same or different exposure times and fused to generate a corrected first image frame with reduced noise compared to the captured first image frame.

In some aspects, a device may include an image signal processor or a processor (e.g., an application processor) including specific functionality for camera controls and/or processing, such as enabling or disabling the binning module or otherwise controlling aspects of the image correction. The methods and techniques described herein may be entirely performed by the image signal processor or a processor, or various operations may be split between the image signal processor and a processor, and in some aspects split across additional processors.

The device may include one, two, or more image sensors, such as a first image sensor. When multiple image sensors are present, the image sensors may be differently configured. For example, the first image sensor may have a larger field of view (FOV) than the second image sensor, or the first image sensor may have different sensitivity or different dynamic range than the second image sensor. In one example, the first image sensor may be a wide-angle image sensor, and the second image sensor may be a tele image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. Any of these or other configurations may be part of a lens cluster on a mobile device, such as where multiple image sensors and associated lenses are located in offset locations on a frontside or a backside of the mobile device. Additional image sensors may be included with larger, smaller, or same field of views. The image processing techniques described herein may be applied to image frames captured from any of the image sensors in a multi-sensor device.

In an additional aspect of the disclosure, a device configured for image processing and/or image capture is disclosed. The apparatus includes means for capturing image frames. The apparatus further includes one or more means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors) and time of flight detectors. The apparatus may further include one or more means for accumulating and/or focusing light rays into the one or more image sensors (including simple lenses, compound lenses, spherical lenses, and non-spherical lenses). These components may be controlled to capture the first and/or second image frames input to the image processing techniques described herein.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The method may be embedded in a computer-readable medium as computer program code comprising instructions that cause a processor to perform the steps of the method. In some embodiments, the processor may be part of a mobile device including a first network adaptor configured to transmit data, such as images or videos in a recording or as streaming data, over a first network connection of a plurality of network connections; and a processor coupled to the first network adaptor and the memory. The processor may cause the transmission of output image frames described herein over a wireless communications network such as a 5G NR communication network.

The foregoing has outlined, rather broadly, the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of an example device for performing image capture from one or more image sensors.

FIG. 2 is a block diagram illustrating an example data flow path for image data processing in an image capture device according to one or more embodiments of the disclosure.

FIG. 3 shows a perspective view of multiple angles of image capture for monocular depth estimation, according to some embodiments of the disclosure.

FIG. 4 shows an overhead view of multiple angles of image capture for monocular depth estimation according to some embodiments of the disclosure.

FIG. 5A shows an example image frame according to one or more embodiments of the disclosure.

FIG. 5B shows an example overlay of an explainability mask on an image frame, according to one or more embodiments of the disclosure.

FIG. 6 shows an example block diagram of a system for depth estimation, according to one or more embodiments of the disclosure.

FIG. 7 shows a flow chart of an example method for depth estimation using multi-source pose merging according to one or more embodiments of the disclosure.

FIG. 8 is a block diagram illustrating an example processor configuration for image data processing in an image capture device according to one or more embodiments of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support image processing, including techniques for combining first and second masks to generate a third mask for depth estimation. Use of two masks, such as two explainability masks, generated using position information from different pose estimation sources to generate a third, combined, explainability mask may allow for more accurate depth estimation through use of multiple position estimation algorithms.

Particular implementations of the subject matter described in this disclosure may be implemented to realize one or more of the following potential advantages or benefits. In some aspects, the present disclosure provides techniques for enhanced accuracy in depth estimation in monocular systems, which may allow for enhanced object detection and tracking using such depth estimation. For example, use of a combined mask for depth estimation may allow for more robust training of depth estimation machine learning algorithms which may enhance depth estimation accuracy and efficiency. Furthermore, in some aspects, the present disclosure provides techniques for multi-path backpropagation in a depth estimation system, such as in a training system for one or more depth estimation machine learning models or networks. Such multi-path propagation may provide faster training time for the depth estimation machine learning models or networks, reduced loss fluctuations, and higher depth estimation accuracy. Furthermore, use of multiple sources of position information may allow for operation of a depth estimation system even when a global positioning system (GPS) is performing a cold start, as position estimation information from an external source, such as a pose network, may provide position information while the GPS is being initialized. Likewise, if a pose network has not yet been fully trained, a positioning engine of the device may provide position estimation information for use in depth estimation and depth network or machine learning model training.

In the description of embodiments herein, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

An example device for capturing image frames using one or more image sensors, such as a smartphone, may include a configuration of one, two, three, four, or more camera modules on a backside (e.g., a side opposite a primary user display) and/or a front side (e.g., a same side as a primary user display) of the device. The devices may include one or more image signal processors (ISPs), Computer Vision Processors (CVPs) (e.g., AI engines), or other suitable circuitry for processing images captured by the image sensors. The one or more image signal processors (ISP) may store output image frames (such as through a bus) in a memory and/or provide the output image frames to processing circuitry (such as an applications processor). The processing circuitry may perform further processing, such as for encoding, storage, transmission, or other manipulation of the output image frames.

As used herein, a camera module may include the image sensor and certain other components coupled to the image sensor used to obtain a representation of a scene in image data comprising an image frame. For example, a camera module may include other components of a camera, including a shutter, buffer, or other readout circuitry for accessing individual pixels of an image sensor. In some embodiments, the camera module may include one or more components including the image sensor included in a single package with an interface configured to couple the camera module to an image signal processor or other processor through a bus.

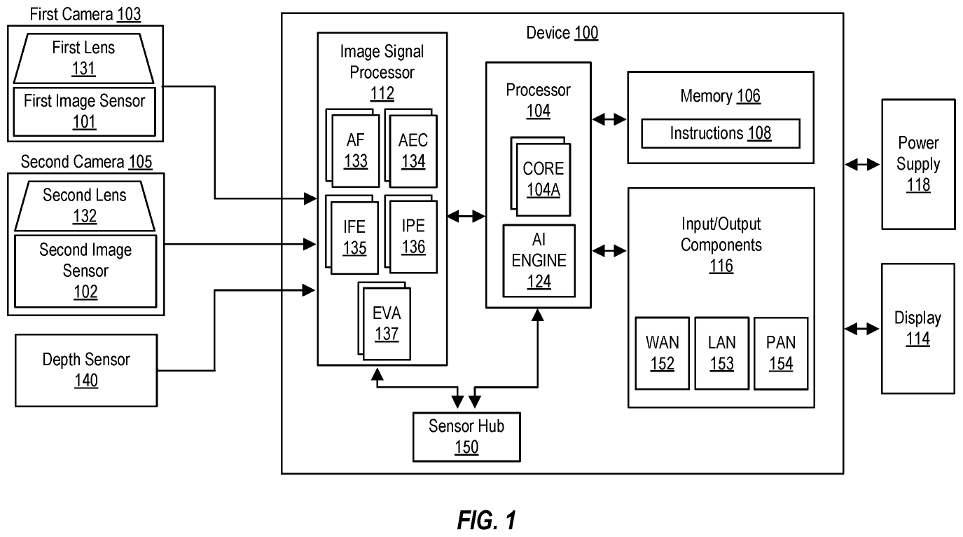

FIG. 1 shows a block diagram of a device 100 for performing image capture from one or more image sensors. The device 100 may include, or otherwise be coupled to, an image signal processor (e.g., ISP 112) for processing image frames from one or more image sensors, such as a first image sensor 101, a second image sensor 102, and a depth sensor 140. In some implementations, the device 100 also includes or is coupled to a processor 104 and a memory 106 storing instructions 108 (e.g., a memory storing processor-readable code or a non-transitory computer-readable medium storing instructions). The device 100 may also include or be coupled to a display 114 and components 116. Components 116 may be used for interacting with a user, such as a touch screen interface and/or physical buttons.

Components 116 may also include network interfaces for communicating with other devices, including a wide area network (WAN) adaptor (e.g., WAN adaptor 152), a local area network (LAN) adaptor (e.g., LAN adaptor 153), and/or a personal area network (PAN) adaptor (e.g., PAN adaptor 154). A WAN adaptor 152 may be a 4G LTE or a 5G NR wireless network adaptor. A LAN adaptor 153 may be an IEEE 802.11 WiFi wireless network adapter. A PAN adaptor 154 may be a Bluetooth wireless network adaptor. Each of the WAN adaptor 152, LAN adaptor 153, and/or PAN adaptor 154 may be coupled to an antenna, including multiple antennas configured for primary and diversity reception and/or configured for receiving specific frequency bands. In some embodiments, antennas may be shared for communicating on different networks by the WAN adaptor 152, LAN adaptor 153, and/or PAN adaptor 154. In some embodiments, the WAN adaptor 152, LAN adaptor 153, and/or PAN adaptor 154 may share circuitry and/or be packaged together, such as when the LAN adaptor 153 and the PAN adaptor 154 are packaged as a single integrated circuit (IC).

The device 100 may further include or be coupled to a power supply 118 for the device 100, such as a battery or an adaptor to couple the device 100 to an energy source. The device 100 may also include or be coupled to additional features or components that are not shown in FIG. 1. In one example, a wireless interface, which may include a number of transceivers and a baseband processor in a radio frequency front end (RFFE), may be coupled to or included in WAN adaptor 152 for a wireless communication device. In a further example, an analog front end (AFE) to convert analog image data to digital image data may be coupled between the first image sensor 101 or second image sensor 102 and processing circuitry in the device 100. In some embodiments, AFEs may be embedded in the ISP 112.

The device may include or be coupled to a sensor hub 150 for interfacing with sensors to receive data regarding movement of the device 100, data regarding an environment around the device 100, and/or other non-camera sensor data. One example non-camera sensor is a gyroscope, which is a device configured for measuring rotation, orientation, and/or angular velocity to generate motion data. Another example non-camera sensor is an accelerometer, which is a device configured for measuring acceleration, which may also be used to determine velocity and distance traveled by appropriately integrating the measured acceleration. In some aspects, a gyroscope in an electronic image stabilization system (EIS) may be coupled to the sensor hub. In another example, a non-camera sensor may be a global positioning system (GPS) receiver, which is a device for processing satellite signals, such as through triangulation and other techniques, to determine a location of the device 100. The location may be tracked over time to determine additional motion information, such as velocity and acceleration. The data from one or more sensors may be accumulated as motion data by the sensor hub 150. One or more of the acceleration, velocity, and/or distance may be included in motion data provided by the sensor hub 150 to other components of the device 100, including the ISP 112 and/or the processor 104.

The ISP 112 may receive captured image data. In one embodiment, a local bus connection couples the ISP 112 to the first image sensor 101 and second image sensor 102 of a first camera 103 and second camera 105, respectively. In another embodiment, a wire interface couples the ISP 112 to an external image sensor. In a further embodiment, a wireless interface couples the ISP 112 to the first image sensor 101 or second image sensor 102.

The first image sensor 101 and the second image sensor 102 are configured to capture image data representing a scene in the field of view of the first camera 103 and second camera 105, respectively. In some embodiments, the first camera 103 and/or second camera 105 output analog data, which is converted by an analog front end (AFE) and/or an analog-to-digital converter (ADC) in the device 100 or embedded in the ISP 112. In some embodiments, the first camera 103 and/or second camera 105 output digital data. The digital image data may be formatted as one or more image frames, whether received from the first camera 103 and/or second camera 105 or converted from analog data received from the first camera 103 and/or second camera 105.

The first camera 103 may include the first image sensor 101 and a first lens 131. The second camera may include the second image sensor 102 and a second lens 132. Each of the first lens 131 and the second lens 132 may be controlled by an associated an autofocus (AF) algorithm (e.g., AF 133) executing in the ISP 112, which adjusts the first lens 131 and the second lens 132 to focus on a particular focal plane located at a certain scene depth. The AF 133 may be assisted by depth data received from depth sensor 140. The first lens 131 and the second lens 132 focus light at the first image sensor 101 and second image sensor 102, respectively, through one or more apertures for receiving light, one or more shutters for blocking light when outside an exposure window, and/or one or more color filter arrays (CFAs) for filtering light outside of specific frequency ranges. The first lens 131 and second lens 132 may have different field of views to capture different representations of a scene. For example, the first lens 131 may be an ultra-wide (UW) lens and the second lens 132 may be a wide (W) lens. The multiple image sensors may include a combination of ultra-wide (high field-of-view (FOV)), wide, tele, and ultra-tele (low FOV) sensors.

Each of the first camera 103 and second camera 105 may be configured through hardware configuration and/or software settings to obtain different, but overlapping, field of views. In some configurations, the cameras are configured with different lenses with different magnification ratios that result in different fields of view for capturing different representations of the scene. The cameras may be configured such that a UW camera has a larger FOV than a W camera, which has a larger FOV than a T camera, which has a larger FOV than a UT camera. For example, a camera configured for wide FOV may capture fields of view in the range of 64-84 degrees, a camera configured for ultra-side FOV may capture fields of view in the range of 100-140 degrees, a camera configured for tele FOV may capture fields of view in the range of 10-30 degrees, and a camera configured for ultra-tele FOV may capture fields of view in the range of 1-8 degrees.

In some embodiments, one or more of the first camera 103 and/or second camera 105 may be a variable aperture (VA) camera in which the aperture can be adjusted to set a particular aperture size. Example aperture sizes include f/2.0, f/2.8, f/3.2, f/8.0, etc. Larger aperture values correspond to smaller aperture sizes, and smaller aperture values correspond to larger aperture sizes. A variable aperture (VA) camera may have different characteristics that produced different representations of a scene based on a current aperture size. For example, a VA camera may capture image data with a depth of focus (DOF) corresponding to a current aperture size set for the VA camera.

The ISP 112 processes image frames captured by the first camera 103 and second camera 105. While FIG. 1 illustrates the device 100 as including first camera 103 and second camera 105, any number (e.g., one, two, three, four, five, six, etc.) of cameras may be coupled to the ISP 112. In some aspects, depth sensors such as depth sensor 140 may be coupled to the ISP 112. Output from the depth sensor 140 may be processed in a similar manner to that of first camera 103 and second camera 105. Examples of depth sensor 140 include active sensors, including one or more of indirect Time of Flight (iToF), direct Time of Flight (dToF), light detection and ranging (Lidar), mm Wave, radio detection and ranging (Radar), and/or hybrid depth sensors, such as structured light sensors. In embodiments without a depth sensor 140, similar information regarding depth of objects or a depth map may be determined from the disparity between first camera 103 and second camera 105, such as by using a depth-from-disparity algorithm, a depth-from-stereo algorithm, phase detection auto-focus (PDAF) sensors, or the like. In addition, any number of additional image sensors or image signal processors may exist for the device 100.

In some embodiments, the ISP 112 may execute instructions from a memory, such as instructions 108 from the memory 106, instructions stored in a separate memory coupled to or included in the ISP 112, or instructions provided by the processor 104. In addition, or in the alternative, the ISP 112 may include specific hardware (such as one or more integrated circuits (ICs)) configured to perform one or more operations described in the present disclosure. For example, the ISP 112 may include image front ends (e.g., IFE 135), image post-processing engines (e.g., IPE 136), auto exposure compensation (AEC) engines (e.g., AEC 134), and/or one or more engines for video analytics (e.g., EVA 137). An image pipeline may be formed by a sequence of one or more of the IFE 135, IPE 136, and/or EVA 137. In some embodiments, the image pipeline may be reconfigurable in the ISP 112 by changing connections between the IFE 135, IPE 136, and/or EVA 137. The AF 133, AEC 134, IFE 135, IPE 136, and EVA 137 may each include application-specific circuitry, be embodied as software or firmware executed by the ISP 112, and/or a combination of hardware and software or firmware executing on the ISP 112.

The memory 106 may include a non-transient or non-transitory computer readable medium storing computer-executable instructions as instructions 108 to perform all or a portion of one or more operations described in this disclosure. The instructions 108 may include a camera application (or other suitable application such as a messaging application) to be executed by the device 100 for photography or videography. The instructions 108 may also include other applications or programs executed by the device 100, such as an operating system and applications other than for image or video generation. Execution of the camera application, such as by the processor 104, may cause the device 100 to record images using the first camera 103 and/or second camera 105 and the ISP 112.

In addition to instructions 108, the memory 106 may also store image frames. The image frames may be output image frames stored by the ISP 112. The output image frames may be accessed by the processor 104 for further operations. In some embodiments, the device 100 does not include the memory 106. For example, the device 100 may be a circuit including the ISP 112, and the memory may be outside the device 100. The device 100 may be coupled to an external memory and configured to access the memory for writing output image frames for display or long-term storage. In some embodiments, the device 100 is a system-on-chip (SoC) that incorporates the ISP 112, the processor 104, the sensor hub 150, the memory 106, and/or components 116 into a single package.

In some embodiments, at least one of the ISP 112 or the processor 104 executes instructions to perform various operations described herein, including multi-source pose merging for depth estimation. For example, execution of the instructions can instruct the ISP 112 to begin or end capturing an image frame or a sequence of image frames, in which the capture includes mask generation and depth estimation as described in embodiments herein. In some embodiments, the processor 104 may include one or more general-purpose processor cores 104A-N capable of executing instructions to control operation of the ISP 112. For example, the cores 104A-N may execute a camera application (or other suitable application for generating images or video) stored in the memory 106 that activate or deactivate the ISP 112 for capturing image frames and/or control the ISP 112 in the application of multi-source pose merging for depth estimation to the image frames. The operations of the cores 104A-N and ISP 112 may be based on user input. For example, a camera application executing on processor 104 may receive a user command to begin a video preview display upon which a video comprising a sequence of image frames is captured and processed from first camera 103 and/or the second camera 105 through the ISP 112 for display and/or storage. Image processing to determine “output” or “corrected” image frames, such as according to techniques described herein, may be applied to one or more image frames in the sequence.

In some embodiments, the processor 104 may include ICs or other hardware (e.g., an artificial intelligence (AI) engine such as AI engine 124 or other co-processor) to offload certain tasks from the cores 104A-N. The AI engine 124 may be used to offload tasks related to, for example, face detection and/or object recognition performed using machine learning (ML) or artificial intelligence (AI). The AI engine 124 may be referred to as an Artificial Intelligence Processing Unit (AI PU). The AI engine 124 may include hardware configured to perform and accelerate convolution operations involved in executing machine learning algorithms, such as by executing predictive models such as artificial neural networks (ANNs) (including multilayer feedforward neural networks (MLFFNN), the recurrent neural networks (RNN), and/or the radial basis functions (RBF)). The ANN executed by the AI engine 124 may access predefined training weights for performing operations on user data. The ANN may alternatively be trained during operation of the image capture device 100, such as through reinforcement training, supervised training, and/or unsupervised training. In some other embodiments, the device 100 does not include the processor 104, such as when all of the described functionality is configured in the ISP 112.

In some embodiments, the display 114 may include one or more suitable displays or screens allowing for user interaction and/or to present items to the user, such as a preview of the output of the first camera 103 and/or second camera 105. In some embodiments, the display 114 is a touch-sensitive display. The input/output (I/O) components, such as components 116, may be or include any suitable mechanism, interface, or device to receive input (such as commands) from the user and to provide output to the user through the display 114. For example, the components 116 may include (but are not limited to) a graphical user interface (GUI), a keyboard, a mouse, a microphone, speakers, a squeezable bezel, one or more buttons (such as a power button), a slider, a toggle, or a switch.

While shown to be coupled to each other via the processor 104, components (such as the processor 104, the memory 106, the ISP 112, the display 114, and the components 116) may be coupled to each another in other various arrangements, such as via one or more local buses, which are not shown for simplicity. One example of a bus for interconnecting the components is a peripheral component interface (PCI) express (PCIe) bus.

While the ISP 112 is illustrated as separate from the processor 104, the ISP 112 may be a core of a processor 104 that is an application processor unit (APU), included in a system on chip (SoC), or otherwise included with the processor 104. While the device 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

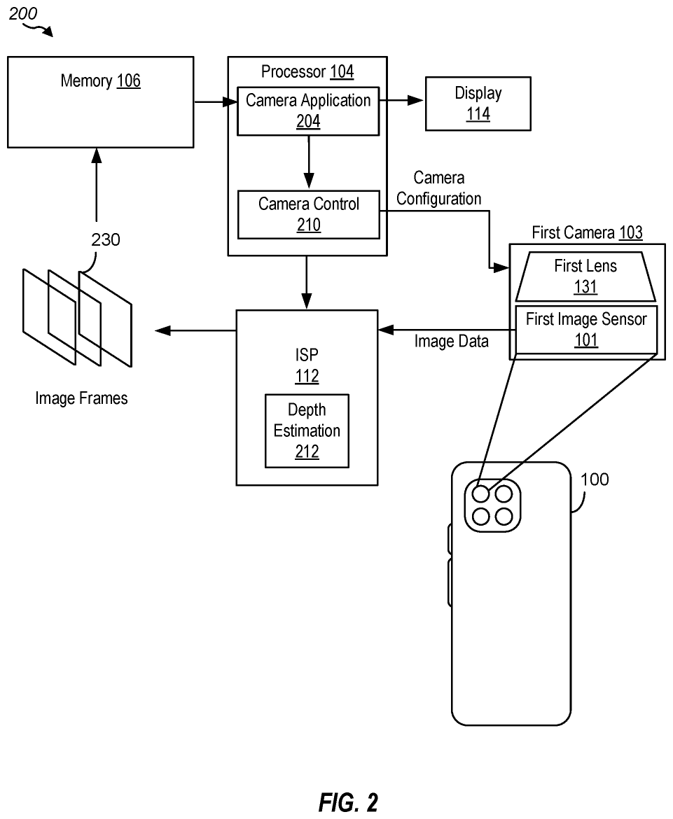

The exemplary image capture device of FIG. 1 may be operated to obtain improved depth estimation information using a mask, such as an explainability mask, generated by combining one or more other explainability masks. One example method of operating one or more cameras, such as first camera 103 and/or second camera 105, is shown in FIG. 2 and described below.

FIG. 2 is a block diagram illustrating an example data flow path for image data processing in an image capture device according to one or more embodiments of the disclosures. Processor 104 of system 200 may communicate with ISP 112 through a bi-directional bus and/or separate control and data lines. The processor 104 may control the first camera 103 through camera control 210. The camera control 210 may be a camera driver executed by the processor 104 for configuring the first camera 103, such as to active or deactivate image capture, configure exposure settings, and/or configure aperture size. Camera control 210 may be managed by a camera application 204 executing on the processor 104. The camera application 204 provides settings accessible to a user such that a user can specify individual camera settings or select a profile with corresponding camera settings. Camera control 210 communicates with the first camera 103 to configure the first camera 103 in accordance with commands received from the camera application 204. The camera application 204 may be, for example, a photography application, a document scanning application, a messaging application, or other application that processes image data acquired from the first camera 103.

The camera configuration may include parameters that specify, for example, a frame rate, an image resolution, a readout duration, an exposure level, an aspect ratio, an aperture size, etc. The first camera 103 may apply the camera configuration and obtain image data representing a scene using the camera configuration. In some embodiments, the camera configuration may be adjusted to obtain different representations of the scene. For example, the processor 104 may execute a camera application 204 to instruct the first camera 103, through camera control 210, to set a first camera configuration for the first camera 103, to obtain first image data from the first camera 103 operating in the first camera configuration, to instruct the first camera 103 to set a second camera configuration for the first camera 103, and to obtain second image data from the first camera 103 operating in the second camera configuration.

In some embodiments in which the first camera 103 is a variable aperture (VA) camera system, the processor 104 may execute a camera application 204 to instruct the first camera 103 to configure to a first aperture size, obtain first image data from the first camera 103, instruct the first camera 103 to configure to a second aperture size, and obtain second image data from the first camera 103. The reconfiguration of the aperture and obtaining of the first and second image data may occur with little or no change in the scene captured at the first aperture size and the second aperture size. Example aperture sizes are f/2.0, f/2.8, f/3.2, f/8.0, etc. Larger aperture values correspond to smaller aperture sizes, and smaller aperture values correspond to larger aperture sizes. That is, f/2.0 corresponds to a larger aperture size than f/8.0.

The image data received from the first camera 103 may be processed in one or more blocks of the ISP 112 to determine output image frames 230 that may be stored in memory 106 and/or otherwise provided to the processor 104. The processor 104 may further process the image data to apply effects to the output image frames 230. Effects may include Bokeh, lighting, color casting, and/or high dynamic range (HDR) merging. In some embodiments, the effects may be applied in the ISP 112.

The output image frames 230 by the ISP 112 may include representations of the scene improved by aspects of this disclosure. In some embodiments, the output image frames 230 may include reconstructed image frames and/or explainability masks as described herein. In some embodiments, such reconstructed image frames and/or explainability masks may be generated using the output image frames 230. The processor 104 may utilize image frames 230 for improved depth estimation to obtain the benefits provided by the described processing implemented in the ISP 112 and/or processor 104. In some embodiments, instead of image frames 230, the ISP may output depth estimation information generated by depth estimation module 212, such as one or more reconstructed versions of image frames 230, one or more explainability masks for such reconstructed versions of frames, photometric loss information, and other loss information. In some embodiments, depth estimation module 212 may be included in one or more processors 104 of the system 200 other than or in addition to the image signal processor 112.

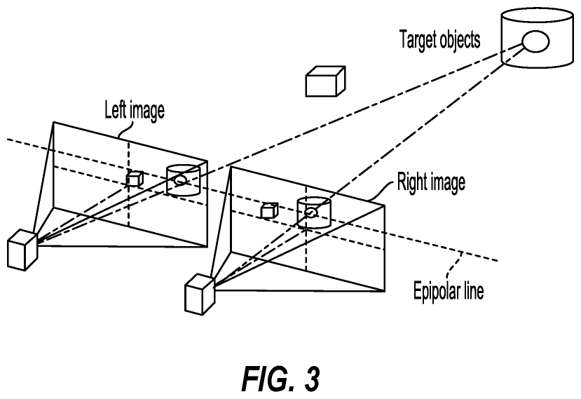

FIG. 3 shows a perspective view of multiple angles of image capture for monocular depth estimation. For example, the left image may be captured by a camera, such as a camera of an autonomous vehicle, a smart phone, a robotic device, or other device, and the right image may be captured by the same camera. A distance of one or more objects from the cameras, or from a common reference point, may be estimated based on a change in position of the object from the left image to the right image and a change in position of the camera from when the left image is captured to when the right image is captured. Monocular depth estimation may be preferred, in some implementations, over stereo depth estimation. For example, monocular systems may be less costly due to use of a single camera to capture the multiple images. Furthermore, monocular systems may not require the calibration between multiple cameras performed in stereo depth estimation systems. For example, stereo depth estimation systems may require a high baseline cost, may encounter synchronization issues, and the systems may have limited overlapping image regions. Monocular depth estimation systems may be particularly useful in automotive applications. For example, depth may be estimated using images captured using a dashcam. Inferring single-image depth using geometric principles alone, however, may present difficulties and introduce potential error.

Machine learning algorithms may be applied in performing monocular depth estimation. For example, self-supervised learning algorithms may be implemented to allow for depth estimation using data captured by a device including a camera. For example, a temporal axis may be used to infer depth. However, self-supervised learning in a monocular depth estimation context may require reliable pose information between sequential frames from either a positioning engine, a pose estimation network, or both to allow for accurate estimation of a relative change in position of a camera from a position at which a first frame is captured to a position at which a second frame is captured. Joint learning of depth and ego-motion may be performed using the self-supervision model. Furthermore, a self-supervised learning model may leverage structure-from-motion (SfM) principles to perform view synthesis as the self-supervision signal. Use of a self-supervised model may allow the self-supervised learning model to be executed without a depth ground truth information set, which may not be readily available. The abundance of video data available may render self-supervised machine learning models for monocular depth estimation particularly useful. As another example, full supervision machine learning algorithms for monocular depth estimation may be used. Full supervision machine learning may include learning a mapping from images to dense depth maps using images associated with real world high-quality depth annotations. Such data sets may, however, not be readily available. As another example, partial supervision machine learning algorithms for monocular depth estimation may be used. Partial supervision machine learning may include reliance primarily on self-supervised machine learning techniques, with application of full-supervision machine learning to small subsets of pixels. Use of partial supervision machine learning may help to resolve issues of scale ambiguity that may be present when using exclusively self-supervised machine learning models for monocular depth estimation.

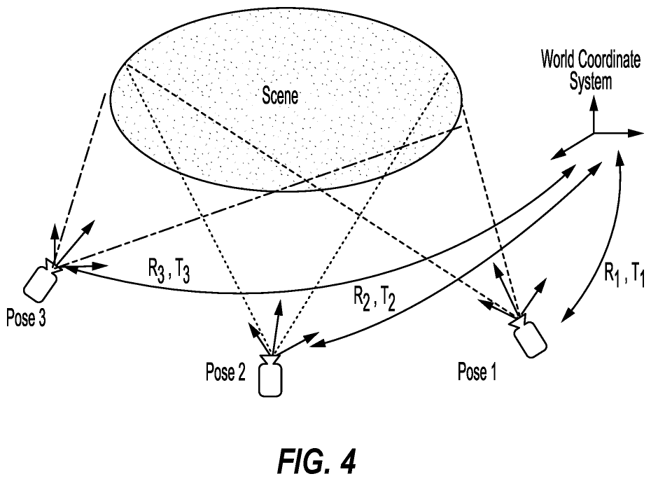

Depth estimation systems, such as monocular depth estimation systems using self-supervised machine learning models, may utilize pose estimation for estimating a position of a camera when multiple frames of a scene are captured. For example, during training of a depth estimation machine learning model, relative pose, also referred to herein as position, between neighboring frames may be estimated. An example, overhead view of multiple angles of frames captured depicting a scene is shown in FIG. 4. At a first time, a camera may be in a first pose 402 and may capture a first frame showing a first view of the scene 410. At a second time, the camera may be in a second pose 404 and may capture a second frame showing a second view of the scene 410. At a third time, the camera may be in a third pose 406 and may capture a third frame showing a third view of the scene 410. Relative positions of the camera during capture of each frame may be estimated. Such relative positions may, for example, include a distance between the camera and a common reference point when each frame is captured, such as an angular distance. In some embodiments, the relative positions may include a rotation and a translation between a reference point and a position of the camera when each frame was captured.

Positioning information for the camera related to each frame may be estimated by multiple sources. As one example, a positioning engine, which may be located in a device including the camera and/or in a remote computing system may use a variety of sources of data for estimating a position of the camera related to each captured frame. As one example, the positioning engine may be a global navigation satellite service (GNSS) system which may use satellite positioning data to estimate a position of the camera associated with each captured frame. As another example, the positioning engine may use information from a variety of sources to obtain more accurate and/or precise position estimations. For example, the positioning engine may be a vision enhanced precise positioning engine (VEPP). Such an engine may combine information regarding a position of the camera during capture of each of the frames from multiple sources. For example, such an engine may combine GNSS information, camera information, inertial measurement information, such as information from an inertial measurement unit (IMU), wheel sensor information, and other information to provide accurate position estimates for a position of the camera when each frame was captured. Such systems may provide accurate and cost-effective global position estimation, which may be accurate to less than a meter.

As another example, a pose estimation network may be used to estimate a position of a camera associated with each of multiple captured frames of a scene. A pose estimation network may be located on one or more remote servers, such as in the cloud. The pose estimation network may be a deep learning-based network to estimate a relative camera position between neighboring frames. The pose network may utilize an encoder backbone such as a residual neural network (ResNet). Such a network may utilize pairs of color images, or six channels, as input and may predict a single six degrees of freedom relative pose transform from one color image or set of channels to the next.

Position information generated using first and second image frames may be used, such as by a view synthesis block, to generate a reconstructed version of a first image frame using the pose information, the second image frame, and depth estimation information. As one example, a neighboring frame I_{S} of a first frame IT may be used with an estimated depth map D_{T}, positioning information T_{t→s}, and camera intrinsics K according to the equation 1 to generate a reconstructed version Îₜ of the first frame I_{T}.

$${\hat{I}}_{t} = {I}_{s} 〈 proj ( {D}_{t} , {T}_{t \to s} , K ) 〉 \qquad ( 1 )$$

In equation 1, [symbol] ⋅ [symbol] may be a sampling operator and proj( ) may be the resulting two-dimensional coordinates of the projected depths D_{T} in I_{S}. Thus, depth information Dr for an image I_{T}, positioning information T_{t→s}, and a neighboring frame I_{S} may be used to generate a reconstructed version Îₜ of the first frame I_{T}.

In some embodiments, monocular depth estimation systems, such as monocular depth estimation systems using self-supervised or partially supervised machine learning algorithms, may use structure from motion (SfM) methods for depth estimation. SfM methods may, in some cases, assume that objects depicted in image frames are static and that only the camera is mobile between capturing of frames of a scene. Such an assumption may, however, not be true. For example, in autonomous driving environments, vehicles and pedestrians may also be moving between frame capture times. Furthermore, an autonomous vehicle may also stop at stop signs, stop lights, and other signals, which may cause the camera capturing the image frames to remain in a single position for multiple frames. Such movement, or lack thereof, may break assumptions on which depth estimation algorithms rest and may lead to error in estimating depth values for pixels corresponding to moving objects. To mitigate such error, masks, such as explainability masks, may be generated for frames and/or frame reconstructions as discussed herein to indicate pixels corresponding to objects that violate assumptions that the that external objects are not moving between frames, that the camera is moving between frames, and/or other assumptions. For example, such masks may indicate one or more pixels that should be ignored or deprioritized for depth estimation purposes. Such masks may include per pixel values indicating which pixels correspond to moving objects.

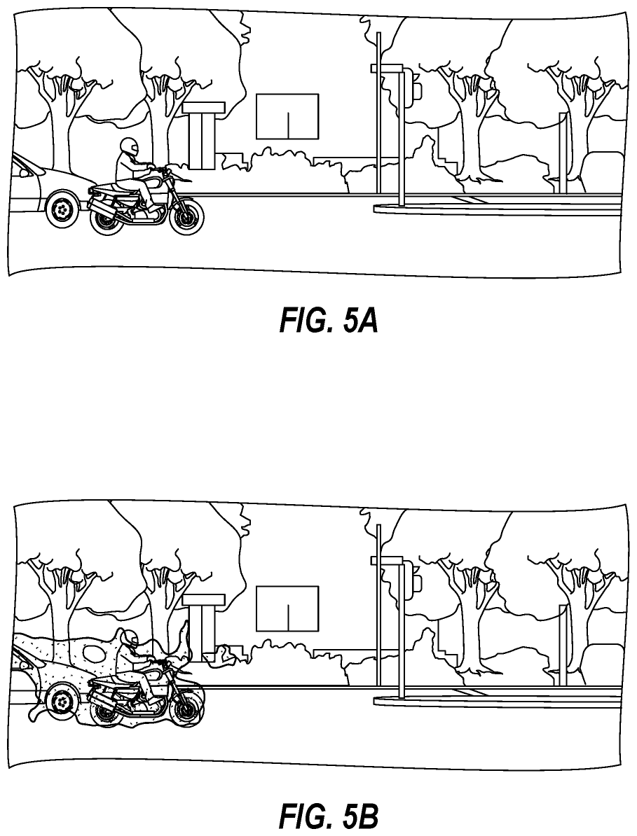

A generated explainability mask may identify, for the purposes of filtering out, pixels that do not change appearance and or position from one frame to the next, as such pixels may correspond to an object that is moving and thus appears stationary from frame to frame. Such masks may allow a depth estimation system to ignore objects that are moving at a same velocity as a camera from frame to frame and may, in some embodiments, allow the depth estimation system to ignore whole frames in monocular videos that are captured where a camera stops moving. An explainability mask may allow a depth estimation system to ignore one or more pixels corresponding to objects determined to be moving between capture of a first frame and capture of a second frame. An example image frame is shown in FIG. 5A. An example mask overlaid on the image frame of FIG. 5A is shown in FIG. 5B. An explainability mask 510 covering the car and bike may indicate that pixels corresponding to the car and bike should be ignored for depth estimation purposes, as the car and bike are not stationary from capture of a first frame to capture of a second frame.

A mask, such as an explainability mask may be generated using several methods. For example, deep learning algorithms may be used to generate a mask. Such generation may include using a deep learning network to generate a predicted mask based on object motion. A predicted mask, such as an explainability mask, may be used in determination of depth estimation loss as a weighting factor. Use of deep learning algorithms may utilize a separate regularization term for the explainability mask to facilitate learning of a non-zero mask by the network. As another example, a binary mask may be calculated automatically on the forward pass of the reconstructed image frame. In contrast with use of deep learning, a binary mask may include binary values associated with each pixel, rather than more granular weighting values. A binary mask μ∈{0, 1} may be calculated in accordance with equations 2 and 3.

$$μ = 1 \qquad ( 2 )$$

$$if$$

$$pe ( {I}_{t} , {\hat{I}}_{t} ) < pe ( {I}_{t} , {I}_{s} )$$

$$μ = 0 \qquad ( 3 )$$

$$if$$

$$pe ( {I}_{t} , {\hat{I}}_{t} ) \geq pe ( {I}_{t} , {I}_{s} )$$

The operator pe( ) may represent photometric reprojection error. Thus, if an error in reproduction between a reconstructed first frame Îₜ and the first frame Iₜ is less than an error between the first frame Iₜ and a second frame Iₛ used in generation of the reconstructed first frame, a masking value for the pixel may be set to 1 and the pixel may be used for depth estimation. Likewise, if an error in reproduction between a reconstructed first frame Îₜ and the first frame Iₜ is greater than or equal to an error between the first frame Iₜ and a second frame Iₛ used in generation of the reconstructed first frame, a masking value for the pixel may be set to 0 and the pixel may be ignored. Thus, the mask may include pixels for depth estimation where a reconstruction error of the reconstructed frame Îₜ is less than the second frame Iₛ.

Training and accuracy of a depth estimation system, such as a depth network, may be impacted by accuracy of position estimation. An accurate pose estimation may result in much higher accuracy in depth estimation and a much higher quality trained depth network. Furthermore, accuracy in pose estimation may significantly reduce a training time for a depth network. Positioning engines and pose estimation networks both have strengths and weaknesses. For example, positioning engines may be unable to tailor position estimations to long-tail scenarios, such as sharp turns or significant bumps and potholes in a road in autonomous driving scenarios. Furthermore, positioning engines may suffer from other shortcomings, such as GNSS-related shortcomings including multi-path effect, sensitivity to radio interference, cold start issues, such as lack of availability immediately upon system startup, and signal loss issues, such as loss of signal resulting from tall buildings, tunnels, and other environmental characteristics. Pose estimation networks may be difficult to train initially, as such networks may have close to random weights. Such weights may create circular dependencies between performance of a depth estimation system, such as a depth network, and the pose network. Furthermore, high bias and variance in training of pose networks may impact an accuracy of a depth estimation system, such as a depth network. For example, out of distribution samples may significantly impact accuracy of position estimation by a pose estimation network, while a positioning engine may provide more robust performance in such scenarios. Furthermore, delay of execution in a pose network may result in delayed position estimates. Loss of neighboring camera frames, such as during transmission to the pose network, may also impact the accuracy of such systems when relying on a pose estimation network.

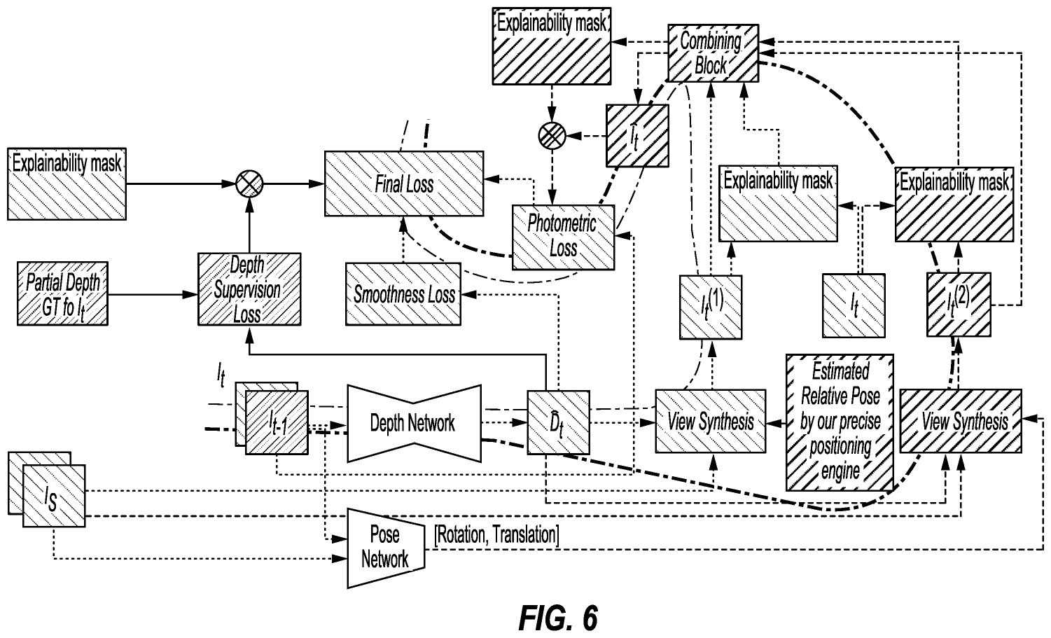

Multi-source pose merging may allow for enhanced accuracy and efficiency in training of a depth estimation system, such as a depth network, and in subsequent depth estimation. An example depth estimation system including multi-source pose merging is shown in FIG. 6. As shown in FIG. 6 an original reference frame I_{T} may be provided to a depth network 602 to generate depth estimation information \hat{D}ₜ. A first view synthesis block 604 may use positioning information received from a positioning engine, the depth estimation information \hat{D}ₜ, and a neighboring frame I_{S} to generate a first reconstructed version of the reference frame Iₜ⁽¹⁾.

The view synthesis block 604 may include logic configured as hardware and/or software that constructs a reconstructed version of the reference frame using information beyond the pixel data of the reference frame (e.g., estimated pose, estimated depth, the neighboring frame pixel data). For example, the view synthesis block 604 may include logic to compute the reference frame Îₜ=Iₛ [symbol] proj(Dₜ, T_{t→s}, K) [symbol] , where < . . . > is the sampling operator, D_{T} is the depth map, T_{t→s} is the estimated pose, K is the camera intrinsics, and proj( ) are the resulting 2D coordinates of the projected depths D_{T} in I_{S}. The output of the view synthesis block 604 is the reconstructed frame that is the original frame at time t captured by the image sensor that is reconstructed using the estimated depth map and/or pose network output. The operation may include processing a frame at a different timestamp, other than 1, and use the estimated (or measured) pose and estimated depth to map that RGB frame to the frame at time t. The view synthesis block 604 may thus reconstruct frame at time t from a frame at another time (e.g., time t−1 or time t+1).

Likewise, the original reference frame I_{T} may be provided, along with the neighboring frame I_{S}, to a pose network 606. The pose network 606 may generate positioning information, which may be used by a second view synthesis block 608, along with the depth estimation information \hat{D}ₜ and the neighboring frame I_{S}, to generate a second reconstructed version of the reference frame Iₜ⁽²⁾.

A first mask 612, such as a first binary explainability mask, may then be generated using the first reconstructed version of the reference frame Iₜ⁽¹⁾ and the reference frame I_{T}. A second mask 614, such as a second binary explainability mask, may also be generated using the second reconstructed version of the reference frame Iₜ⁽²⁾ and the reference frame I_{T}.

The reconstructed frames and the first and second masks 612, 614 may then be combined to generate a third, combined, reconstructed version of the reference frame Îₜ and a corresponding combined mask 616. The combined reference frame and mask 616, generated using explainability masks generated using position information from a positioning engine and a pose network, may allow depth estimation from a camera system operated as shown in FIG. 4 or other configurations to operate with enhanced accuracy and may reduce a training time of the depth estimation system.

Generation of the third, combined reconstructed version of the reference frame Îₜ may be performed at combining block 630 based on the two input explainability masks 612, 614 and the two input reconstructed versions of the reference frame. The combining block 630 may also generate the third, combined mask 616 may be generated based on the first and second masks 612, 614. The combining block 630 may apply one or more rules applied to the inputs to determine the third, combined mask 616 and the reconstructed reference frame Îₜ.

As one example, if the mask value for each of the first and second masks 612, 614 for a pixel is zero, the third, combined, explainability mask 616 may assign a value of 0 to the corresponding pixel in the third mask. Any value may be assigned to the pixel in the third, combined, reconstructed version of the reference frame Îₜ as the value of 0 corresponding to the pixel in the mask may cause the depth estimation algorithm to ignore the pixel, such as to ignore the pixel in a loss calculation. If one of the two input masks has a value of one corresponding to a pixel, while the other of the two input masks has a value of zero corresponding to the pixel, the third, combined mask may assign a value of one to the corresponding pixel of the third mask. The third, combined reconstructed version of the reference frame Îₜ may assign the same value to the pixel of the third reconstructed version of the reference frame Îₜ that is assigned to the pixel in the reconstructed version of the reference frame corresponding to the explainability mask that assigned a value of one to the pixel. If both of the two input masks assign a value of one to the input pixel, the third, combined explainability mask may assign a value of one to the corresponding pixel.

Furthermore, the third, combined, version of the reference frame Îₜ may assign an average of values of the pixel in the reconstructed versions of the reference frame Îₜ associated with the two input masks to the pixel, may assign a value from one of the two input reconstructed versions of the reference frame that would result in a lowest final loss value, or may otherwise determine a value of the pixel in the third reconstructed version of the reference frame Îₜ. As one example, the third, combined output mask μₜ(i, j) may be calculated in accordance with formulas 3-7, where i and j are coordinates of particular pixels and k is an index of an explainability mask for which the value at pixel (i,j) is 1. U1 may be the set of such indices k at time t. Thus, depending on the explainability masks at time t, different sets of k may satisfy such a condition.

$${μ}_{t} \to Final output mask \qquad ( 3 )$$

$${μ}_{t}^{1} , {μ}_{t}^{2} , … , {μ}_{t}^{n} \to Input masks \qquad ( 4 )$$

$$U = \{ {μ}_{t}^{1} , {μ}_{t}^{2} , … , {μ}_{t}^{n} \} \qquad ( 5 )$$

$${U}_{1} ( i , j ) = \{ k \vert {μ}_{t}^{k} ( i , j ) = 1 ; {μ}_{t}^{k} ϵ U \} \qquad ( 6 )$$

$${μ}_{t} ( i , j ) = \{ \begin{matrix}0 , & {U}_{1} ( i , j ) = ∅ \\ 1 & else\end{matrix} \qquad ( 7 )$$

The third, combined reproduction of the reference frame [symbol] (i, j) may be calculated in accordance with one or more of formulas 8-10, such as by taking a mean of values of pixels according to equation 8 or using a particular pixel value according to equation 9.

$$( i , j ) = mean ( {I}_{t}^{( k )} ( i , j ) ) \qquad ( 8 )$$

$$∀ k ∈ {U}_{1} ( i , j )$$

$$( i , j ) = {I}_{t}^{( z )} ( i , j ) \qquad ( 9 )$$

$$z = arg min ( pe ( {I}_{t}^{( k )} ( i , j ) ) ) \qquad ( 10 )$$

$$∀ k ∈ {U}_{1} ( i , j )$$

The third, combined mask and the third, combined reproduction of the reference frame [symbol] may be combined, such as to instruct the depth estimation system to ignore pixels of the third, combined reproduction of the reference frame [symbol] that are assigned a value of zero by the third, combined mask. A photometric loss block 622 may estimate a photometric loss using the third, combined mask and the third, combined reproduction of the reference frame [symbol] . Furthermore, a smoothness loss block 624 may estimate a smoothness loss in accordance with the depth estimation information \hat{D}ₜ. Likewise, a depth supervision loss block 626 may determine a depth supervision loss using the depth estimation information \hat{D}ₜ and partial depth ground truth information or frame I_{T}. The depth supervision loss may be masked using an explainability mask, such as the first mask used to generate the third, combined mask discussed herein or another mask, to limit an impact of a depth supervision loss to pixels in the frame that do not have an explainable depth, such as pixels of the frame associated with a value of 0 in a binary explainability mask. A final loss function block 628 may combine the depth supervision loss, the photometric loss, and the smoothness loss to determine a final loss value for training the depth estimation system, such as for training the depth network.

A depth estimation machine learning algorithms, which may enhance depth estimation accuracy and efficiency, may be trained using the photometric loss, smoothness loss, and final loss value. For example, in some aspects, the present disclosure provides techniques for multi-path backpropagation in a depth estimation system, such as in a training system for one or more depth estimation machine learning models or networks. Such multi-path propagation, suing the photometric loss, smoothness loss, and other losses and value disclosed herein may provide faster training time for the depth estimation machine learning models or networks, reduced loss fluctuations, and higher depth estimation accuracy.

In some embodiments, a depth network, as referred to herein, may include one or more depth models. The depth estimation system of FIG. 6 may provide multiple backpropagation paths through a depth network of the depth estimation system, shown by the dotted lines, which may provide faster training time for the depth network, reduced loss fluctuations, and higher depth estimation accuracy.

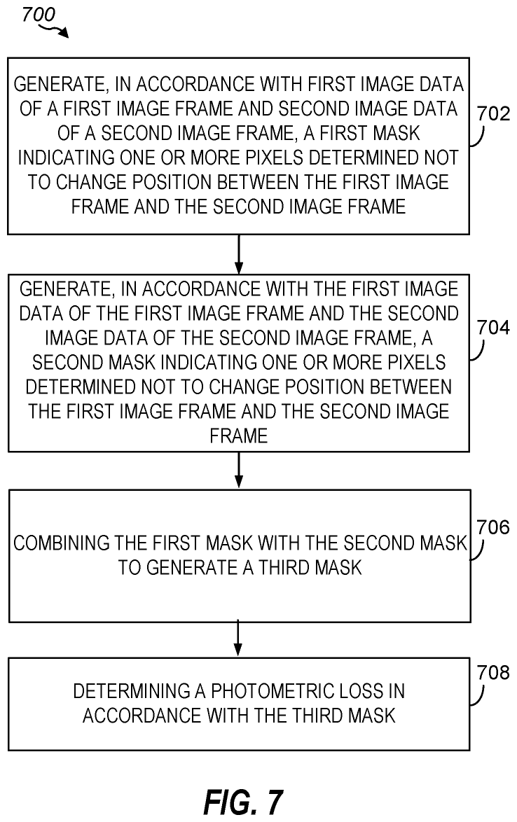

The system 200 of FIG. 2 may be configured to perform the operations described with reference to FIG. 7 to train a depth estimation system and/or perform depth estimation using image frames 230. The system 200 may, for example, be a system of an autonomous vehicle, an assistive robotics system, an augmented or virtual reality scene composition system, an image editing system, or other system. FIG. 7 shows a flow chart of an example method for generating a combined mask for use in training a depth estimation system and/or performing depth estimation according to some embodiments of the disclosure. The generation of the combined mask in FIG. 7 may provide an improved mask using multiple positioning information sources, as described herein. Each of the operations described with reference to FIG. 7 may be performed by one or a combination of the processor 104 (including cores 104A-N or AI engine 124) and/or the ISP 112.

At block 702, a first mask may be generated in accordance with first image data of a first image frame and second image data of a second image frame. The first mask may, for example, indicate one or more pixels determined not to change position between the first image frame and the second image frame. The first mask may, for example, be a first explainability mask, as described herein. In some embodiments, the first mask may be a binary explainability mask, with a value assigned to each pixel of a reconstructed version of the first frame. A value of 1 may indicate that the pixel did change position between the first image frame and the second image frame, and a value of 0 may indicate that the pixel did not change position between the first image frame and the second image frame. In some embodiments, a lack of a change of position for a pixel between a first frame and a second frame may indicate that the pixel corresponds to an object that is moving between the first frame and the second frame, such as an object moving at a same speed as a camera that captured the first frame and the second frame. The first mask may, for example, be generated using first positioning information received from a positioning engine. Such positioning information may, for example, include information indicating a position of a camera that captured the first and second frames when the first frame was captured and when the second frame was captured. In some embodiments, such positioning information may include relative positioning information for a position of the camera when each of the first and second frames was captured, such as a rotation and a translation between a reference point and a position of the camera when the first frame was captured and the second frame was captured. In some embodiments, generation of the first mask may include generating a first reconstructed version of the first frame using the first positioning information, the second image data, and depth information for the first frame. Then, the first mask may be generated using the first reconstructed version of the first frame and the first frame.

At block 704, a second mask may be generated in accordance with the first image data of the first image frame and the second image data of the second image frame. The second mask may, for example, indicate one or more pixels determined not to change position between the first image frame and the second image frame. The second mask may, for example, be a second explainability mask, as described herein. In some embodiments, the second mask may be a binary explainability mask, with a value assigned to each pixel of a reconstructed version of the first frame. A value of 1 may indicate that the pixel did change position between the first image frame and the second image frame, and a value of 0 may indicate that the pixel did not change position between the first image frame and the second image frame. In some embodiments, a lack of a change of position for a pixel between a first frame and a second frame may indicate that the pixel corresponds to an object that is moving between the first frame and the second frame, such as an object moving at a same speed as a camera that captured the first frame and the second frame. The second mask may, for example, be generated using second positioning information received from a pose estimation network, which may also be referred to herein as a pose network. Such positioning information may, for example, include information indicating a position of a camera that captured the first and second frames when the first frame was captured and when the second frame was captured. In some embodiments, such positioning information may include relative positioning information for a position of the camera when each of the first and second frames was captured, such as a rotation and a translation between a reference point and a position of the camera when the first frame was captured and the second frame was captured. In some embodiments, generation of the second mask may include generating a second reconstructed version of the first frame using the second positioning information, the second image data, and depth information for the first frame. Then, the second mask may be generated using the second reconstructed version of the first frame and the first frame.

At block 702, the first mask and the second mask may be combined to generate a third mask. The third mask may likewise be a binary explainability mask. Combination of the first mask with the second mask to generate the third mask may include determining a first mask value of a first pixel of the first mask, determining a second mask value of a second pixel of the second mask, wherein the second pixel corresponds to the first pixel, and determining a combined mask value for a third pixel of the third mask in accordance with the first mask value and the second mask value, where the third pixel corresponds to the first and second pixels. For example, determining the combined mask value of the third pixel may include determining a highest mask value of the first mask value and the second mask value. For example, if either or both of the corresponding pixels of the first and second masks are assigned a value of one, the corresponding pixel of the third, combined, mask may be assigned a value of one. However, both of the corresponding pixels of the first and second mask are assigned a value of zero, the corresponding pixel of the third, combined, mask may be assigned a value of zero. In some embodiments, a third, combined, reconstructed version of the first frame may be generated based on first and second reconstructed versions of the first frame, as described herein.

At block 708, a photometric loss may be determined in accordance with the third mask. In some embodiments, such a loss ay be determined based on the third mask and the third reconstructed version of the reference frame. In some embodiments, a final loss may be determined based on the photometric loss, a smoothness loss, and a depth supervision loss, and the final loss may be used to train a depth estimation system, such as one or more depth networks.

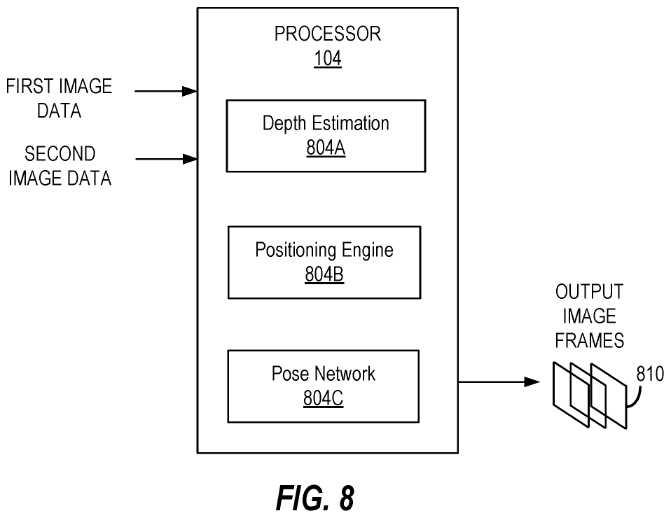

FIG. 8 is a block diagram illustrating an example processor configuration for image data processing in an image capture device according to one or more embodiments of the disclosure. The processor 104, or other processing circuitry, may be configured to operate on image data to perform one or more operations of the method of FIG. 7. The image data may be processed to determine one or more output image frames 810. Such output image frames may include reconstructed versions of a first frame, as discussed herein, one or more explainability masks, or other frames.

The processor 104 receives first image data for a first frame and second image data for a second frame. In some embodiments, the first image data may be received directly from the image sensor or a memory coupled to the image sensor. In some embodiments, the first image data may be retrieved from long-term storage, such as flash storage device or network location, storing a picture that was previously captured or generated. For example, a depth estimation module 804A may include a depth estimation network and/or machine learning training module. The depth estimation module 804A may generate reconstructed versions of reference frames and explainability masks as described herein for purposes of depth estimation and/or training of one or more depth estimation machine learning models of the depth estimation module 804A. Input image data may be provided to positioning engine 804B and pose network 804C for generating positioning estimation information for a camera that captured the input images. Such positioning estimation information may be provided to the depth estimation module 804A for depth estimation and/or training of one or more depth estimation models. The pose network may, in some embodiments, be located in whole or in part outside of processor 104, such as on one or more cloud-based servers. The depth estimation module 804A may generate reconstructed versions of reference frames and/or explainability masks which may be output as image frames 810, used to train one or more depth estimation models, and/or used for depth estimation. In some embodiments depth estimation information from depth estimation module 804A may be used to enhance one or more output image frames 810.

In one or more aspects, techniques for supporting image processing may include additional aspects, such as any single aspect or any combination of aspects described below or in connection with one or more other processes or devices described elsewhere herein. In a first aspect, supporting image processing may include an apparatus configured to perform operations comprising generating, in accordance with first image data of a first image frame and second image data of a second image frame, a first mask indicating one or more pixels determined not to change position between the first image frame and the second image frame, generating, in accordance with the first image data and the second image data, a second mask indicating one or more pixels determined not to change position between the first image frame and the second image frame, and combining the first mask with the second mask to generate a third mask.

Additionally, the apparatus may perform or operate according to one or more aspects as described below. In some implementations, the apparatus includes a wireless device, such as a UE. In some implementations, the apparatus includes a remote server, such as a cloud-based computing solution, which receives image data for processing to determine output image frames. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, the first mask comprises a first explainability mask, the second mask comprises a second explainability mask, and the third mask comprises a third explainability mask.

In a third aspect, in combination with one or more of the first aspect or the second aspect, generating the first mask comprises generating the first mask in accordance with first positioning information indicating a position of a camera that captured the first frame and the second frame from a positioning engine and generating the second mask comprises generating the second mask in accordance with second positioning information indicating the position of the camera that captured the first frame and the second frame from a pose estimation network.

In a fourth aspect, in combination with one or more of the first aspect through the third aspect, generating the first mask in accordance with the first positioning information from the positioning engine comprises: receiving, from the positioning engine, the first positioning information, generating a first reconstructed version of the first frame in accordance with the first positioning information, the second image data, and depth information for the first frame, and generating the first mask in accordance with the first reconstructed version of the first frame and the first frame.

In a fifth aspect, in combination with one or more of the first aspect through the fourth aspect, generating the second mask in accordance with the second positioning information from the pose estimation network comprises: receiving, from the pose estimation network, the second positioning information, generating a second reconstructed version of the first frame in accordance with the second positioning information, the second image data, and depth information for the first frame, and generating the second mask in accordance with the second reconstructed version of the first frame and the first frame.

In a sixth aspect, in combination with one or more of the first aspect through the fifth aspect, the apparatus is further configured to perform operations comprising generating a third reconstructed version of the first frame in accordance with the first reconstructed version of the third frame and the second reconstructed version of the first frame.

In a seventh aspect, in combination with one or more of the first aspect through the sixth aspect, the apparatus is further configured to perform operations comprising determining a photometric loss in accordance with the third mask; and training a depth estimation network based on the photometric loss.

In an eighth aspect, in combination with one or more of the first aspect through the seventh aspect, combining the first mask with the second mask to generate the third mask comprises: determining a first mask value of a first pixel of the first mask, determining a second mask value of a second pixel of the second mask, wherein the second pixel corresponds to the first pixel, and determining a combined mask value for a third pixel of the third mask in accordance with the first mask value and the second mask value, wherein the third pixel corresponds to the first and second pixels.

In a ninth aspect, in combination with one or more of the first aspect through the eighth aspect, determining the combined mask value for the third pixel comprises determining a highest mask value of the first mask value and the second mask value.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any electronic device including, coupled to, or otherwise processing data from one, two, or more image sensors capable of capturing image frames (or “frames”). The terms “output image frame,” “modified image frame,” and “corrected image frame” may refer to an image frame that has been processed by any of the disclosed techniques to adjust raw image data received from an image sensor. Further, aspects of the disclosed techniques may be implemented for processing image data received from image sensors of the same or different capabilities and characteristics (such as resolution, shutter speed, or sensor type). Further, aspects of the disclosed techniques may be implemented in devices for processing image data, whether or not the device includes or is coupled to image sensors. For example, the disclosed techniques may include operations performed by processing devices in a cloud computing system that retrieve image data for processing that was previously recorded by a separate device having image sensors.

Unless specifically stated otherwise as apparent from the following discussions, it is appreciated that throughout the present application, discussions using terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating,” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices. The use of different terms referring to actions or processes of a computer system does not necessarily indicate different operations. For example, “determining” data may refer to “generating” data. As another example, “determining” data may refer to “retrieving” data.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the description and examples herein use the term “device” to describe various aspects of the disclosure, the term “device” is not limited to a specific configuration, type, or number of objects. As used herein, an apparatus may include a device or a portion of the device for performing the described operations.

Certain components in a device or apparatus described as “means for accessing,” “means for receiving,” “means for sending,” “means for using,” “means for selecting,” “means for determining,” “means for normalizing,” “means for multiplying,” or other similarly-named terms referring to one or more operations on data, such as image data, may refer to processing circuitry (e.g., application specific integrated circuits (ASICs), digital signal processors (DSP), graphics processing unit (GPU), central processing unit (CPU), computer vision processor (CVP), or neural signal processor (NSP)) configured to perform the recited function through hardware, software, or a combination of hardware configured by software.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to the Figures referenced above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIGS. 6-8 may be combined with one or more blocks (or operations) described with reference to another of the figures. For example, one or more blocks (or operations) of FIG. 7 may be combined with one or more blocks (or operations) of FIGS. 1-2. As another example, one or more blocks associated with FIG. 8 may be combined with one or more blocks (or operations) associated with FIGS. 1-2.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits, and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Additionally, a person having ordinary skill in the art will readily appreciate, opposing terms such as “upper” and “lower,” or “front” and back,” or “top” and “bottom,” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown, or in sequential order, or that all illustrated operations be performed to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

The term “substantially” is defined as largely, but not necessarily wholly, what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for depth estimation, comprising:
generating, in accordance with first image data of a first image frame and second image data of a second image frame, a first mask indicating one or more pixels determined not to change position between the first image frame and the second image frame;
generating, in accordance with the first image data and the second image data, a second mask indicating one or more pixels determined not to change position between the first image frame and the second image frame, wherein the first mask and the second mask are generated using at least some different input data; and
combining the first mask with the second mask to generate a third mask.

2. The method of claim 1, wherein the first mask comprises a first explainability mask, the second mask comprises a second explainability mask, and the third mask comprises a third explainability mask.

3. The method of claim 1, wherein generating the first mask comprises generating the first mask in accordance with first positioning information indicating a position of a camera that captured the first image frame and the second image frame from a positioning engine and generating the second mask comprises generating the second mask in accordance with second positioning information indicating the position of the camera that captured the first image frame and the second image frame from a pose estimation network.

4. The method of claim 3, wherein generating the first mask in accordance with the first positioning information from the positioning engine comprises:
receiving, from the positioning engine, the first positioning information;
generating a first reconstructed version of the first image frame in accordance with the first positioning information, the second image data, and depth information for the first image frame; and
generating the first mask in accordance with the first reconstructed version of the first image frame and the first image frame.

5. The method of claim 4, wherein generating the second mask in accordance with the second positioning information from the pose estimation network comprises:
receiving, from the pose estimation network, the second positioning information;
generating a second reconstructed version of the first image frame in accordance with the second positioning information, the second image data, and depth information for the first image frame; and
generating the second mask in accordance with the second reconstructed version of the first image frame and the first image frame.

6. The method of claim 5, further comprising generating a third reconstructed version of the first image frame in accordance with the first reconstructed version of the third image frame and the second reconstructed version of the first image frame.

7. The method of claim 1, further comprising:
determining a photometric loss in accordance with the third mask; and
training a depth estimation network based on the photometric loss.

8. The method of claim 1, wherein combining the first mask with the second mask to generate the third mask comprises:
determining a first mask value of a first pixel of the first mask;
determining a second mask value of a second pixel of the second mask, wherein the second pixel corresponds to the first pixel; and
determining a combined mask value for a third pixel of the third mask in accordance with the first mask value and the second mask value, wherein the third pixel corresponds to the first and second pixels.

9. The method of claim 8, wherein determining the combined mask value for the third pixel comprises determining a highest mask value of the first mask value and the second mask value.

10. An apparatus, comprising:
a memory storing processor-readable code; and
at least one processor coupled to the memory, the at least one processor configured to execute the processor-readable code to cause the at least one processor to perform operations including:
generating, in accordance with first image data of a first image frame and second image data of a second image frame, a first mask indicating one or more pixels determined not to change position between the first image frame and the second image frame;
generating, in accordance with the first image data and the second image data, a second mask indicating one or more pixels determined not to change position between the first image frame and the second image frame, wherein the first mask and the second mask are generated using at least some different input data; and
combining the first mask with the second mask to generate a third mask.

11. The apparatus of claim 10, wherein the first mask comprises a first explainability mask, the second mask comprises a second explainability mask, and the third mask comprises a third explainability mask.

12. The apparatus of claim 10, wherein generating the first mask comprises generating the first mask in accordance with first positioning information indicating a position of a camera that captured the first image frame and the second image frame from a positioning engine and generating the second mask comprises generating the second mask in accordance with second positioning information indicating the position of the camera that captured the first image frame and the second image frame from a pose estimation network.

13. The apparatus of claim 12, wherein generating the first mask in accordance with the first positioning information from the positioning engine comprises:
receiving, from the positioning engine, the first positioning information;
generating a first reconstructed version of the first image frame in accordance with the first positioning information, the second image data, and depth information for the first image frame; and
generating the first mask in accordance with the first reconstructed version of the first image frame and the first image frame.

14. The apparatus of claim 13, wherein generating the second mask in accordance with the second positioning information from the pose estimation network comprises:
receiving, from the pose estimation network, the second positioning information;
generating a second reconstructed version of the first image frame in accordance with the second positioning information, the second image data, and depth information for the first image frame; and
generating the second mask in accordance with the second reconstructed version of the first image frame and the first image frame.

15. The apparatus of claim 14, wherein the at least one processor is further configured to perform steps comprising generating a third reconstructed version of the first image frame in accordance with the first reconstructed version of the third image frame and the second reconstructed version of the first image frame.

16. An apparatus, comprising:
at least one image sensor configured to capture first image data and second image data;
a positioning engine;
a memory storing processor-readable code; and
at least one processor coupled to the memory, to the at least one image sensor, and to the position engine, the at least one processor configured to execute the processor-readable code to cause the at least one processor to perform operations including:
generating, in accordance with the first image data of a first image frame and second image data of a second image frame, a first mask indicating one or more pixels determined not to change position between the first image frame and the second image frame;
generating, in accordance with the first image data and the second image data, a second mask indicating one or more pixels determined not to change position between the first image frame and the second image frame, wherein the first mask and the second mask are generated using at least some different input data; and
combining the first mask with the second mask to generate a third mask,
wherein:
generating the first mask comprises generating the first mask in accordance with first positioning information indicating a position of the at least one image sensor that captured the first image frame and the second image frame from the positioning engine, and
generating the second mask comprises generating the second mask in accordance with second positioning information indicating the position of the at least one image sensor that captured the first image frame and the second image frame from a pose estimation network.

17. The apparatus of claim 16, wherein the first mask comprises a first explainability mask, the second mask comprises a second explainability mask, and the third mask comprises a third explainability mask.

18. The apparatus of claim 17, wherein generating the first mask in accordance with the first positioning information from the positioning engine comprises:
receiving, from the positioning engine, the first positioning information;
generating a first reconstructed version of the first image frame in accordance with the first positioning information, the second image data, and depth information for the first image frame; and
generating the first mask in accordance with the first reconstructed version of the first image frame and the first image frame.

19. The apparatus of claim 18, wherein generating the second mask in accordance with the second positioning information from the pose estimation network comprises:
receiving, from the pose estimation network, the second positioning information;
generating a second reconstructed version of the first image frame in accordance with the second positioning information, the second image data, and depth information for the first image frame; and
generating the second mask in accordance with the second reconstructed version of the first image frame and the first image frame.

20. The apparatus of claim 19, wherein the at least one processor is further configured to perform steps comprising generating a third reconstructed version of the first image frame in accordance with the first reconstructed version of the third image frame and the second reconstructed version of the first image frame.
